(19) United States
(12) Patent Application Publication
(10) Pub. No.: US 2011/0088481 A1
(43) Pub. Date: Apr. 21, 2011

(54) ATTACHMENT DISPLACEMENT SENSOR FOR MEASURING THE CHANGE IN LENGTH OF A SAMPLE AND MEASURING METHOD WHICH USES SUCH A SENSOR

(75) Inventors: Norbert Dahlem, Leverkusen (DE); Jan Kuhnke, Leichlingen (DE)

(73) Assignee: Bayer MaterialScience AG, Leverkusen (DE)

(21) Appl. No.: 12/999,468

(22) PCT Filed: Jun. 16, 2009
(86) PCT No.: PCT/EP09/04302

§ 371 Date: Dec. 16, 2010

(30) Foreign Application Priority Data
Jun. 17, 2008 (DE) 10 2008 028 403.3

(51) Int. Cl. G01N 3/08

(52) U.S. Cl. 73/826

(57) ABSTRACT

The present invention relates to a contact displacement sensor for use in the mechanical measurement of the elongation of a sample by stretching. It further relates to a method for the measurement of the elongation of a sample using such a contact displacement sensor, a system for the measurement of the elongation of a sample using such a contact displacement sensor as well as the use of such a contact displacement sensor. The contact displacement sensor comprises an element with which the sample is contacted. According to the present invention the element is mounted rotatably and disposed in such a way that the tearing of the sample will rotate the element. Due to the element being rotated by the torn sample, only a small amount of energy will be transferred to the contact displacement sensor, which therefore will not be overloaded or damaged.

The present invention relates to a contact displacement sensor for use in the mechanical measurement of the elongation of a sample by stretching. It further relates to a method for the measurement of the elongation of a sample using such a contact displacement sensor, a system for the measurement of the elongation of a sample using such a contact displacement sensor as well as the use of such a contact displacement sensor.

In mechanical elongation measuring procedures, where a contact displacement sensor contacts the sample, the contact displacement sensors are mounted free of play and very easily moveably, so as to ensure an extremely rigid and free of play transmission of the displacement in the direction of the elongation to be measured. The contact force of the contact displacement sensor on the sample should be as low as possible, so that the expansion and fracture behaviour of notch-sensitive samples will be uninfluenced as far as possible.

Therefore, the mountings of the contact displacement sensors and their sensor systems are very sensitive against overload. For example, this might occur when samples tear during stretching and the remains of the samples recoil in an uncontrolled manner and strike against the contact displacement sensors. Especially while testing extremely elastic and energy-rich materials, for example elastomers, this may lead to considerable damages, both on the contact displacement sensors and on the measuring system as a whole.

From DE 7804241 U1 an elongation sensor for the measurement of the elongation of samples subjected to tension or pressure is known. It comprises two pairs of adjustably mounted sensors that are capable of directly contacting the sample with measuring knife edges at the front end of the sensor and that transmit the change of displacement between the two sensor pairs for the generation of a corresponding measurement signal. Here the measuring knife edges are located at cutting pieces which are pivotably mounted on the front end of the sensors, wherein the axis of rotation of the cutting pieces is oriented largely perpendicular to the direction of the change in displacement to be measured. The measuring position of the cutting pieces, in which they are oriented on each sensor pair with their cutting knife edges opposite each other, is defined by a force dependent fixture which allows the cutting pieces to pivot around their axis of rotation under a given pivoting moment acting upon them.

A disadvantage of such a design for an elongation sensor is that the measuring knife edges can pivot against their fixture and that the acting forces are then transferred onto the sensor and can damage it. Damages could also consist in that the cutting pieces cannot pivot back and hence the apparatus needs to be repaired and adjusted manually.

In an automated analytical laboratory this leads to a loss of capacity, especially when the apparatus stands still on an overnight test run and the samples can not be tested until the next morning.

Furthermore, sensors comprising very small knurled brass reels with an integrated ratchet mechanism are known, where due to their constructive embodiment high forces are transferred onto the sensors. In addition to that, here the ratchet mechanism is very complex and does not have a continuous transmission characteristic due to the catch points and dead centres arranged on the circumference. Known optical displacement sensors avoid the danger of a mechanical damage but hold the disadvantage that the elongation range up to over 1000% is not mapped reliably because the necessary marking of the samples is problematic.

Therefore, contact displacement sensors would be desirable where a sample that has torn and recoiled under elongation leads to little or no damage at the contact displacement sensors or the measuring system. A method for measuring the elongation of a sample would also be desirable where energy rich elastomer samples can be tested automatically and with fewer interruptions.

According to the present invention a contact displacement sensor for use in the mechanical measurement of the elongation of a sample by stretching is proposed, comprising a sensor finger connected to a rotationally symmetric element, wherein the element is mounted rotatably, the rotary axis of the element is also the geometric rotational axis of the element, and the element comprises a peripheral surface formed around its rotational axis with which the sample may be contacted.

The movably mounted contact displacement sensor according to the present invention comprises a sensor finger connected to a rotationally symmetric element. The rotationally symmetric element is preferably formed by a complete rotation of its cross-sectional profile around its geometric rotational axis. By mounting the rotationally symmetric element rotatably around its geometric rotational axis, the effort for the adjustment and/or the repair of the contact displacement sensor prior to each measuring procedure can be avoided because a rotation of the element due to a tearing of the sample does not influence the positioning of the contact displacement sensor.

In addition to that, the rotationally symmetric element, for example a roll-shaped or barrel-shaped element, reduces the likelihood of slipping with improperly clamped samples and therefore of errors in measurement. In order to avoid the slipping of the contact displacement sensor, the surface of the element, with which it touches the sample, may be formed in a suitable way or may be composed of a suitable material.

Suitable materials for the surface of the element or for the whole element may, for example, be chosen from the group comprising stainless steel, aluminium and/or polytetrafluoroethylene (PTFE). The element preferably features a diameter of ≧10 mm to ≦50 mm, more preferred of ≧15 mm to ≦40 mm, most preferred of ≧20 mm to ≦30 mm.

Due to the rotationally symmetric form of the element, the distance between the contact displacement sensor and the sample stays the same at any given time, even if the element has been rotated after the tearing of a sample. The positive effect of the present invention is achieved in particular by the constant large and unchanging distance of the contact displacement sensor axis to the sample.

Therefore, a direct contact between sample and contact displacement sensor or sensor system is avoided.

Due to the rotationally symmetric shape of the element, it is also achieved that at the moment of the tearing of the sample it will not entangle with the element and that hence no damaging amount of energy will be transferred from the recoiling sample onto the contact displacement sensor or the sensor system.

The static friction of the element is overcome by the recoiling sample and the element is set into rotation without a jolt. Thereby, most of the energy directed against the contact displacement sensor is converted into rotational energy and the contact displacement sensor and the sensor system are protected against damage. Due to its geometry, a resetting and adjustment of the element into its measurement position is not necessary because the cross sectional profile facing the sample stays unchanged. Hence, the distance between the rotary axis of the element and the sample stays unchanged. Advantageously, the contact displacement sensor is mounted in such a way that the rotary axis of the element is perpendicular to the stretching direction of the sample.

The rotary axis of the element may, for example, be congruent with the central axis of the sensor finger, parallel to the central axis of the sensor finger or be arranged at an angle to the central axis of the sensor finger.

Due to the particular construction of the contact displacement sensor it is also suitable for the measurement of samples with very high elongations, for example of 1000% or higher, and/or high stored energies during the expansion. Furthermore, the contact displacement sensor is especially suited for use in an automated sample testing because a contact displacement sensor according to the invention does not need to be newly adjusted prior to each measuring operation. The automated handling is further supported in that the reduction of the risk of damage to the contact displacement sensor or the sensor system leads to a longer durability of the measuring system.

In an embodiment of the contact displacement sensor, the element is formed in the shape of a roll whose peripheral surface is convexly curved. This means that the peripheral surface, with which the element may contact the sample, is bent outwardly in a spherical or convex manner. Due to the spherical or convex embodiment, there is not a line contact but a nearly punctiform contact between the element and the sample. This increases the accuracy of the test readings, particularly for large elongations. Furthermore, the peripheral surface of the element then does not comprise any edges, so that a notching of the sample and therefore false test readings are avoided.

In a further embodiment of the contact displacement sensor, the element is connected to the sensor finger by a bearing. Due to the bearing the element is not only mounted pivotably but also rotatably, so that the element may rotate around its geometric rotational axis and a torn recoiling sample may not get entangled with the element. The bearing of the element is preferably designed free of play in order to ensure precise test readings. By way of example, cone bearings or needle bearings made from suitable materials may be used for the bearing. Furthermore, a bearing without rolling elements may be used, for example in form of a bushing or as an integral component of the element itself, made of a suitable, slick material, for example PTFE. However, it is preferred that the bearing is designed as a ball bearing.

In a further embodiment of the contact displacement sensor, the rotational resistance of the element is adjustable by a friction clutch. Because of the adjustable rotational resistance, a picking-up of the contact displacement sensor is ensured during a continuous motion due to the elongation of the sample. If a jerky motion occurs, for example at the moment of tearing, the static friction of the roll is overcome and the element is set in rotation without a jerk. Thus, a large portion of the energy directed against the element and the contact displacement sensor is converted into rotational energy and hence the contact displacement sensor as well as the measurement system are protected against damage.

Here, it is preferred that the friction clutch is designed as an adjustable spring-slip ring-system. This implies that the rotational resistance of the element may be adjusted by a pressure spring which is pretensioned manually via a regulating screw arranged on the central axis of the sensor finger at the element side, which in turn presses a pressure ring against the element and therefore generates the rotational resistance. The element is equally rotatable in both directions of rotation. Complex coupling elements, for example those in a ratchet, are not needed.

In a further embodiment of the contact displacement sensor, the rotary axis of the element is spaced apart from the central axis of the sensor finger. Thereby the sensor finger, especially with highly elastic and highly extendable materials, may be spaced further apart from the sample, so that the danger of damaging the sensor finger as well as the measuring system is further reduced.

A further aspect of the present invention is a method for the measurement of the elongation of a sample by stretching in a stretching direction, wherein at least one contact displacement sensor according to the present invention contacts the sample with the peripheral surface of the rotationally symmetric element and wherein the contact displacement sensor is disposed in such a way that the rotary axis of the element is perpendicular to the stretching direction of the sample.

The method according to the present invention therefore relates to the measurement of the elongation of a sample, wherein the elongation is measured by contacting the sample with contact displacement sensors which are made to keep track in case of an extension of the sample. The tracking of the contact displacement sensors gives the measurement readings from which the elongation distance is calculated.

The stretching direction of the sample, when tearing at the end point of the elongation, is also the direction in which the two remains of the sample recoil. Due to the rotary axis of the element being perpendicular to the stretching direction, the linear movement of the remains of the sample may be transformed into a rotation of the element when hitting the element of the contact displacement sensor. Thereby damage is being avoided, as already described above.

In an embodiment of the method at least one pair of contact displacement sensors according to the invention, which are arranged opposite to each other, contact the sample with their respective peripheral surfaces of the rotationally symmetric elements. Furthermore, the contact displacement sensors are arranged in such a way that the respective rotary axes of the elements are perpendicular to the stretching direction of the sample. In a pair of oppositely arranged contact displacement sensors, they are located on opposing sides of the sample.

Additionally, an aspect of the present invention is a system for the measurement of the elongation of a sample by stretching, comprising a contact displacement sensor according to the present invention. Such a system may for example be commercially available equipment for the measurement of the elongation of samples, in which the commercially available contact displacement sensors, which for example are designed in the form of measuring knife edges, have been replaced by contact displacement sensors according to the present invention. Advantageously the contact displacement sensors in this system are mounted in such a way that the rotary axis of the element is perpendicular to the stretching direction of the sample.

In an embodiment of the system at least one pair of contact displacement sensors according to the invention, which are arranged opposite to each other, are adapted contact the sample with their respective peripheral surfaces of the rotationally symmetric elements. Furthermore, the contact displacement sensors are arranged in such a way that the respective rotary axes of the elements are perpendicular to the stretching direction of the sample. In a pair of oppositely arranged contact displacement sensors, they are located on opposing sides of the sample.

A further aspect of the present invention is also the use of a contact displacement sensor according to the present invention for measuring of the elongation of a sample by stretching.

The invention will now be described in more detail on the basis of preferred embodiments with reference to the accompanying drawings, in which:

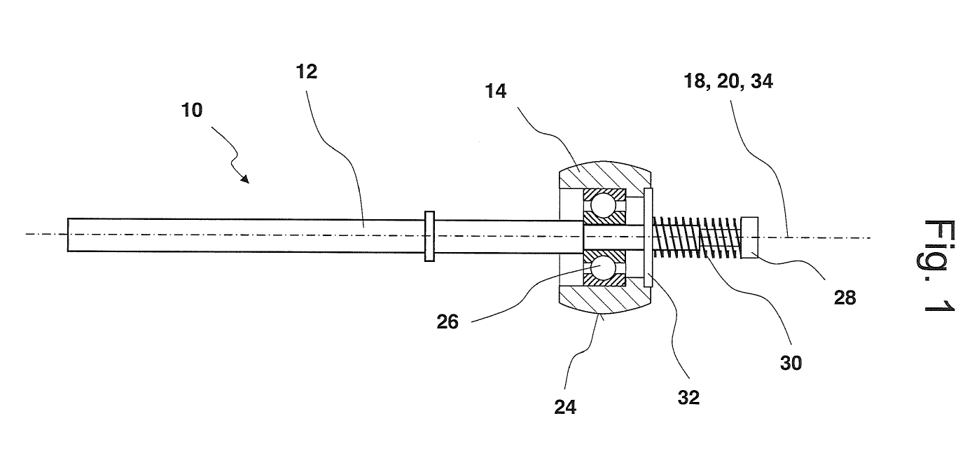

FIG. 1: is a schematic view of a contact displacement sensor according to the present invention

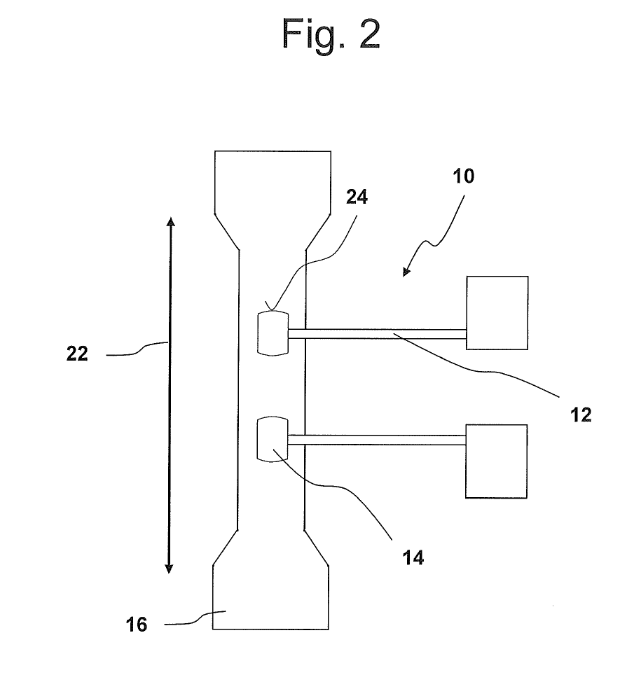

FIG. 2: is a schematic, perspective view of an arrangement of contact displacement sensors for the measurement of the elongation of a sample

FIG. 1 shows a schematic view of a contact displacement sensor according to the present invention. The contact displacement sensor 10 comprises a sensor finger 12, on whose end which is facing the sample an element 14 is mounted which may contact the sample 16 with its peripheral surface 24. The geometric rotational axis 20 of the element 10 corresponds to its rotary axis 18 which is located on the central axis 34 of the sensor finger 12.

The element 14 is mounted by a ball bearing 26 so that it may rotate around its rotary axis 18. The rotational resistance of the element 14 is adjustable by a spring-slip ring-system. Through the regulating screw 28 the pressure spring 30 is pretensioned, which exerts a spring force onto the pressure ring 32 and is being pressed against the element 14.

FIG. 2 shows a schematic, perspective view of an arrangement of contact displacement sensors for the measurement of the elongation of a sample, as it is employed in the method of the present invention. The shown contact displacement sensors 10 are respectively located in pairs at either side of the sample 16 at two measuring positions. Thereby the barrel-shaped bodies 14 of the contact displacement sensors 10 contact the sample 16 with their respective spherically formed peripheral surface 24. Due to the spherical forming of the peripheral surface 24, a nearly punctiform contact is achieved.

The rotary axis of the element 14 corresponds to the central axis of the sensor finger 12 and the rotational axis of the element 14, whereby the peripheral surface 24 of is formed. According to the present invention the rotary axis of the element 14 is perpendicular to the stretching direction 22. Because the peripheral surface 24 which has been defined by a rotation contacts the sample, the positioning in space of the contact displacement sensor 10 is defined.

An elongation occurs during the stretching of the sample 16 in the stretching direction 22, which the contact displacement sensors 10 track and thus enable a technically measurable registration of the elongation. The sample 16 is thereby stretched until it tears. After tearing the two pieces of the sample 16 recoil past the bodies 14 of the contact displacement sensors 10 back to their original length.

1-12. (canceled)

13. A contact displacement sensor for use in the mechanical measurement of the elongation of a sample by stretching, comprising:
a sensor finger connected to a rotationally symmetric element, wherein the element is rotatably mounted, with a rotational axis of the element also being a geometric rotational axis of the element, the element including a peripheral surface formed around the rotational axis for contacting the sample.

14. The contact displacement sensor according to claim 13, wherein the element is formed in the shape of a roll whose peripheral surface is curved convexly.

15. The contact displacement sensor according to claim 13, wherein the element is connected to the sensor finger by a bearing.

16. The contact displacement sensor according to claim 15, wherein the bearing is designed as a ball bearing.

17. The contact displacement sensor according to claim 13, wherein the rotational resistance of the element is adjustable by a friction clutch.

18. The contact displacement sensor according to claim 17, wherein the friction clutch is designed as an adjustable spring-slip ring-system.

19. The contact displacement sensor according to claim 13, wherein the rotary axis of the element is spaced apart from the central axis of the sensor finger.

20. A method for the measurement of the elongation of a sample by stretching in a stretching direction, comprising:
placing at least one contact displacement sensor adjacent the sample, wherein each contact displacement sensor comprises a sensor finger connected to a rotationally symmetric element, the element being rotatably mounted, with a rotational axis of the element also being a geometric rotational axis of the element, the element including a peripheral surface formed around the rotational axis for contacting the sample, such that the rotational axis of each rotationally symmetric element is perpendicular to the stretching direction of the sample; and
contacting the sample with the peripheral surface of the rotationally symmetric element of each contact displacement sensor.

21. The method according to claim 20, wherein placing at least one contact displacement sensor adjacent the sample includes placing at least one pair of the contact displacement sensors adjacent the sample opposite each other.

22. A system for the measurement of the elongation of a sample by stretching, comprising at least one contact displacement sensor including a sensor finger connected to a rotationally symmetric element, the element being rotatably mounted, with a rotational axis of the element also being a geometric rotational axis of the element, the element including a peripheral surface formed around the rotational axis for contacting the sample.

23. The system according to claim 22, wherein the at least one contact displacement sensor comprises at least one pair of contact displacement sensors arranged opposite to each other, each contact displacement sensor being adapted to contact the sample with the peripheral surfaces of the respective rotationally symmetric elements and being arranged with the rotational axis of the respective element perpendicular to the stretching direction of the sample.
